(19) United States
(12) Patent Application Publication
(10) Pub. No.: US 2025/0381564 A1
(43) Pub. Date: Dec. 18, 2025

(54) MICROFLUIDIC DEVICES, SYSTEMS, AND METHODS FOR FABRICATING IMPRINTED POLYMERS FOR CAPTURE OR DETECTION OF BIOLOGICAL OR CHEMICAL SUBSTANCES

(71) Applicants: Pouya REZAI, Richmond Hill, CA (US); Alireza Zabihihesari, Halifax, CA (US); Ali Doostmohammadi, Toronto (CA); Ayobami Elisha Oseyemi, Toronto (CA); John Brown, Calgary, CA (US)

(72) Inventors: Pouya REZAI, Richmond Hill, CA (US); Alireza Zabihihesari, Halifax, CA (US); Ali Doostmohammadi, Toronto (CA); Ayobami Elisha Oseyemi, Toronto (CA); John Brown, Calgary, CA (US)

(21) Appl. No.: 18/746,886

(22) Filed: Jun. 18, 2024

(51) Int. Cl. B01L 3/00

(52) U.S. Cl. CPC B01L 3/502707; B01L 3/502715; B01L 2300/0645; B01L 2300/0854

(57) ABSTRACT

Provided are a microfluidic device, a system, and a method for fabricating imprinted polymers for capture or detection of biological or chemical substances. The method including: preparing one or more prepolymerization mixtures, each prepolymerization mixture including a respective target template, the target template including one or more target molecules, one or more target ions, or one or more target cells; directing each of the one or more prepolymerization mixtures into a respective microchannel of one or more microchannels of a microfluidic device; polymerizing the prepolymerization mixture into imprinted polymers having a targeted structure by directing a heat source or a light source, or both, at the one or more microchannels; and providing the imprinted polymers for capture or detection of the biological or chemical substances. Also provided is a microfluidic device for detection or measurement of a target analyte, the target analyte including a molecule, ion, or cell.

### TECHNICAL FIELD

The following relates generally to chemical and biological sample preparation and sensing methods and technologies, and more specifically, to microfluidic devices, systems, and methods for fabricating imprinted polymers for capture or detection of biological or chemical substances.

### BACKGROUND

Imprinted polymers (IPs) are synthetic receptors that selectively recognize and bind target analytes based on their shape and chemistry, with much lower cost, shorter synthesis time, and higher thermal and chemical stability compared to other, more conventional, biorecognition elements (e.g., antibodies, aptamers, enzymes, and active proteins). IPs' capacity to be tailor-made for analytes for which a biological receptor does not exist significantly expands their range of applications. IP microstructures possess high physicochemical stability which improve their durability under harsh conditions and enable their application in a wide range of areas, from biomedical detection to environmental analysis and industrial processes. However, there remains significant problems to high-throughput and precise structuring of IPs for fabrication.

### SUMMARY

In aspect of the present invention, there is provided a method for fabricating imprinted polymers for capture or detection of biological or chemical substances, the method comprising: preparing one or more prepolymerization mixtures, each prepolymerization mixture comprising a respective target template, the target template comprising one or more target molecules, one or more target ions, or one or more target cells; directing each of the one or more prepolymerization mixtures into a respective microchannel of one or more microchannels of a microfluidic device; polymerizing the prepolymerization mixture into imprinted polymers having a targeted structure by directing a heat source or a light source, or both, at the one or more microchannels; and providing the imprinted polymers for capture or detection of the biological or chemical substances.

In a particular case of the method, the targeted structure of the imprinted polymers comprises one or more membranes or one or more pillars.

In another case of the method, the one or more membranes or the one or more pillars comprise imprinted polymers for more than one target template.

In yet another case of the method, the one or more membranes or the one or more pillars each comprise a layer of non-imprinted polymer at a core.

In yet another case of the method, the targeted structure of the imprinted polymers are droplets, the method further comprising outputting the droplets.

In yet another case of the method, the method further comprises curing the droplets into particles.

In yet another case of the method, where there is a plurality of microchannels, each of the microchannels have a prepolymerization mixture with a different target template directed therethrough, wherein each of the microchannels merge prior to the application of the heat source and/or the light source, and wherein the imprinted polymers are multiplex.

In yet another case of the method, a mask is located between the heat source and/or the light source and the one or more microchannels comprising the prepolymerization mixture, the mask is configured to permit selective polymerization of local areas of the prepolymerization mixture to govern the targeted structure of the imprinted polymers.

In yet another case of the method, the method further comprises integrating electrodes into a housing that houses the one or more membranes or the one or more pillars to form an electrochemical sensor.

In yet another case of the method, the prepolymerization mixture comprises a single target template, and wherein the imprinted polymers are singleplex.

In another aspect, there is provided a microfluidic device for fabricating imprinted polymers for capture or detection of biological or chemical substances, the microfluidic device comprising: one or more input microchannels to each receive a prepared prepolymerization mixture, each prepolymerization mixture comprising a respective target template, the target template comprising one or more target molecules, one or more target ions, or one or more target cells; and a downstream microchannel in fluid communication with the one or more input microchannels, the downstream microchannel configured to receive heat from a heat source or receive light from a light source, or both, to polymerize the prepolymerization mixture into imprinted polymers having a targeted structure.

In a particular case of the microfluidic device, the targeted structure of the imprinted polymers comprises one or more membranes or one or more pillars.

In yet another case of the microfluidic device, the one or more membranes or the one or more pillars comprise imprinted polymers for more than one target template.

In yet another case of the microfluidic device, the one or more membranes or the one or more pillars each comprise a layer of non-imprinted polymer at a core of the membrane.

In yet another case of the microfluidic device, the targeted structure of the imprinted polymers are droplets, wherein the downstream microchannel outputs the droplets.

In yet another case of the microfluidic device, the droplets are cured into particles.

In yet another case of the microfluidic device, where there is a plurality of input microchannels, each of the input microchannels have a prepolymerization mixture with a different target template directed therethrough, and wherein the outputted imprinted polymers are multiplex.

In yet another case of the microfluidic device, the device further comprising a mask located between the heat source and/or the light source and the one or more input microchannels comprising the prepolymerization mixture, the mask is configured to permit selective polymerization of local areas of the prepolymerization mixture to govern the targeted structure of the imprinted polymers.

In another aspect, there is provided a microfluidic device for detection or measurement of a target analyte, the target analyte comprising a molecule, ion, or cell, the microfluidic device comprising: a housing; an imprinted polymer situated in the housing, the imprinted polymer fabricated using a prepolymerization mixture comprising one or more target templates for the target analytes and that is polymerized in one or more microchannels; and electrodes integrated in the housing, the electrodes in communication with the imprinted polymer to form a sensor.

These and other embodiments are contemplated and described herein. It will be appreciated that the foregoing summary sets out representative aspects of systems, devices, and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of a system for fabricating imprinted polymers for capture or detection of biological or chemical substances using microfluidics, in accordance with an embodiment;

FIG. 2 is a flowchart of a method for fabricating imprinted polymers for capture or detection of biological or chemical substances using microfluidics, in accordance with an embodiment;

FIG. 3 is a schematic diagram of an example implementation of the system of FIG. 1 for fabricating microstructures of imprinted polymers (IPs), via IP droplets, for biological and chemical sensing and preparation applications;

FIG. 4 illustrates a schematic of a microfluidic device for fabricating imprinted polymers by preparing IP droplets, for capture or detection of biological or chemical substances, in accordance with a particular embodiment;

FIG. 5 is a microscopic image of microfluidic IP droplet generation with various parameters visualized;

FIG. 6A is a chart illustrating normalized droplet gap by orifice versus flow rate ratio;

FIG. 6B is a chart illustrating normalized frequency of droplet generation by average frequency for all trials versus flow rate ratio;

FIG. 7 is a chart showing a comparison of droplet diameter versus flow rate ratio for various tested devices

FIGS. 8A and 8B are outputs of a Scanning Electron Microscopy (SEM) showing a uniform, surface morphology for non-imprinted polymer (NIP) microparticles, illustrated for unwashed particles in FIG. 8A and washed particles in FIG. 8B;

FIG. 9 illustrates a schematic of a microfluidic device with embedded IP structures (in this example, labeled as an Ion-Selective Polymeric (ISP) membrane), and with electrodes, for capture and/or detection of biological or chemical substances, in accordance with another embodiment;

FIGS. 10A and 10B are charts showing electrode stability, where FIG. 10A shows a V-I curve showing a linear correlation between applied voltage and current output, and FIG. 10B shows cyclic voltammetry (CV) demonstrating no electrode oxidation;

FIG. 11 is a chart showing the microfluidic device's sensitivity to NaCl and KCl salts due to use of ISP membranes specific to capturing and detection of these salts;

FIG. 12 is a chart showing the non-interfering effect of sodium nitrate, sodium sulphate, and potassium nitrate ions on the detection of 100 ppm of NaCl when an NaCl-specific ISP membrane was used in the microfluidic device;

FIG. 13 illustrates an example of in-situ fabrication of electrodes for the microfluidic device;

FIG. 14 illustrates an example of fabrication of an ISP membrane;

FIG. 15A shows a linear plot and FIG. 15B shows a semi-log plot of dose-response curves for an ISP membrane-integrated device and a device with the membrane lacking the ion-exchanging monomers;

FIGS. 16A and 16B illustrate the results showing NaCl and KCl dose-response curves for the membrane-less microfluidic device in FIG. 16A, and for the ISP membrane-integrated microfluidic device in FIG. 16B;

FIG. 17 is an example schematic representation of synthesis of a Na⁺-IP membrane;

FIG. 18A shows a Fourier Transform Infrared Spectroscopy (FT-IR) spectra of leached 17 and un-leached Na⁺-IP membranes;

FIG. 18B shows an energy dispersive X-ray analysis (i) and a scanning electron micrograph (ii) of the Na⁺-IP;

FIG. 19A shows a comparison of two sensor configurations, one with a non-imprinted polymer (NIP) and another with the Na⁺-IP;

FIG. 19B shows a summary of a trend of performance enhancement from the ISP membrane to the non-imprinted polymer (NIP) membrane; and

FIGS. 20A and 20B are charts showing results of a specificity study for the Na⁺-IP sensor.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to chemical and biological sensors, affinity reagents, and controlled capturing/releasing modules, and more specifically, to a microfluidic device, a method, and a system for fabricating imprinted polymers for capture or detection of biological or chemical substances. The fabricated IP used in ready-to-use sample preparation kits, and cartridges. The microstructures or nanostructures fabricated can be used, for example, for detecting and/or extracting molecules using a molecularly imprinted polymer, for detecting and/or extracting ions using an ion imprinted polymer, or for detecting and/or extracting cells using a cell imprinted polymer.

Traditional imprinted polymer (IP) sensing typically involves direct modification of sensing platforms with imprinted polymers by coating a thin IP film covalently on transducers, e.g., working electrode in electrochemical sensors or fluorescent microparticles and sheets in colorimetric sensors. Various coating techniques have been developed to produce a thin IP film on planar transducers, e.g., screen-printed electrodes (SPEs) and non-planar transducers such as microspheres and microwires. Yet, IP coating techniques rely on time- and labour-intensive transducer functionalizing processes which could result in the loss of electrodes after use. The present embodiments disintegrate IPs from transducers via standalone IP microstructures and eliminates the need for surface functionalizing on working electrodes. In addition to being used as selective receptors in sensors, standalone IP nano- and micro-structures can serve as alternatives to IP-coated surfaces and improve their function as drug carriers and controlled-release systems in biomedical treatment, pharmaceutical industry, food analysis, separation and purification.

Application of traditional methods, like precipitation polymerization, to produce standalone IPs are generally limited to creating singleplex microspheres. Such methods lack sufficient control to generate size-controllable and monodispersed particles or multicompartmental microstructures of any shapes; e.g., microspheres, micropillars, and membranes. Additionally, conventional imprinting reactions, such as bulk polymerization or surface imprinting, are typically conducted in a closed environment with constant stirring or shaking, making it difficult to achieve a continuous synthesis process and often requiring multiple batches for mass production. Moreover, IPs synthesized using conventional polymerization strategies often come with drawbacks like buried binding sites and slow mass transfer rates, restricting diffusion into imprinted sites.

Microfluidic devices enable precise control over the fluid flow, mixing process, and controlled interfaces in case of immiscible fluids. This property is particularly useful for creating highly reproducible and homogeneous IP-based products with tailored sizes, shapes, and functionalities. Other attempts for integration of standalone IP microstructure synthesis with microfluidics are limited to producing only singleplex microparticles using basic droplet generation devices, or improving IP prepolymer dispensing via varied microchannel flow rates. Some microfluidic devices involve the assembly of plastic tubes (e.g., PTFE and Teflon) to create basic droplet generation systems, but their adaptability to other designs is significantly restricted. Other techniques, like 3D printing and lithography, have only been examined predominantly for singleplex particles with a limited range of IP compositions for analytes only at molecular level.

Advantageously, the present embodiments overcome substantial challenges in the art, such as development of multifunctional (e.g., Janus and tertiary) and complex IP micro/nanostructures using microfluidics. For example, microfluidic droplet generation requires flow of immiscible fluids in microchannels that exhibit coalescence-resistant behaviour. This criterion limits one's freedom in selecting IP ingredients, especially the solvent and the continuous phase. On the other hand, new IP compositions are needed to produce IPs with affinity to a wide range of analytes from molecular to cellular levels. Another substantial challenge overcome by the present embodiments are alterations in continuous phase's fluid properties (e.g., viscosity, and density) during thermal-polymerization or photo-polymerization; which affect the interdroplet spacing and may cause particle agglomeration and clogging of the microchannels. Moreover, a further substantial challenge overcome by the present embodiments is the adhesion of microparticles during polymerization to microchannels walls and proper collection of microdroplets from the outlet without affecting their shapes.

Unlike other IP polymerization approaches, which often lead to bulk polymers, regolith, or irregular sized/shape particles and powders, the microfluidic-based polymerization of IPs provided in the present embodiments advantageously enables achieving microstructures of controlled shapes and sizes which are suitable for singleplex (i.e., imprinted with only one analyte) or multiplex (i.e., imprinted with multiple analytes) applications.

In addition to microfluidics, previous efforts have been made toward the use of rapid prototyping to synthetize 3D IPs with high-resolution according to a pre-designed structure. Photopolymerization is a potential approach for fabrication of complex polymer structures, especially free-standing 3D structure IPs through accurate spatial control of the polymerization. However, following photostructuring, multistep procedures such as thermal annealing need to be done to obtain the desired properties. For example, fabrication of 3D IP structures with submicrometric resolution using a two-photon stereolithography (TPS) approach. TPS enabled generation of 3D IP microstructures with high surface-to-volume ratio and porous structures with high accessibility to the imprinted binding sites. However, TPS typically involves more sophisticated equipment and specialized materials compared to other microfabrication technologies. This can result in higher costs and ongoing operational expenses. Additionally, the time required to create microstructures using TPS can be longer than other approaches, which can impact overall cost considerations. While TPS can potentially offer high resolution and the capability to produce intricate IP microstructures, incorporating these delicate, pre-made structures into other sensors or microfluidic devices can present substantial challenges. In contrast, the 3D printing approach of the present embodiments facilitates the use of SLA printing as a cost-effective additive manufacturing technology for on-site production of small IP microstructures within microchannel networks. It further advantageously allows for simultaneous fabrication of both microchannels and IP structures in unison.

As described above, despite numerous attempts, commercializing IPs remains a significant problem in the art. There are serious obstacles with respect to developing microstructures with a wide range of shapes and sizes and entirely made of IPs, which are “standalone”; meaning that they are disintegrated from a core electrode to function as independent capturing/releasing modules. Additionally, there are significant obstacles with respect to developing and optimizing standalone IPs with affinity to whole pathogens like viruses and bacteria, rather than molecules. Further, there are significant obstacles with respect to developing standalone “multicompartmental” (or “multiplex”) IP microstructures with affinity to more than one target analyte for multiplex detection, capturing, and realising applications. Finally, there are significant obstacles with respect to transforming these standalone IP microstructures to sensors; i.e., IP-based chemical and biological sensors

The present embodiments advantageously solve these significant problems in the art. Embodiments of the present disclosure include approaches that provide IP chemistry for specific affinity: IPs provide unique opportunities for detecting and containing future pandemics at the initial phases where antibodies and aptamers are being developed against the pathogen. IP composition including the type and amount of functional monomers (FMs), cross-linkers (CLs), solvents, initiators, and inhibitors required for synthesizing IPs, as well as IP polymerization recipes and conditions, can be optimized to provide affinity to a wide range of analytes from antibiotics, RNA, electrolyte ions, and heavy metals to whole pathogens like viruses and bacteria.

Further, embodiments of the present disclosure include approaches that provide IP structuring. Using microfluidics and 3D printing, different approaches are provided for generating standalone 2D and 3D nano- and micro-structures entirely made of IPs in the shape of multicompartmental films, membranes and microdroplets; e.g., Janus and tertiary microdroplets.

Furthermore, embodiments of the present disclosure include approaches that provide integrated IP-microsensors for detecting chemical-biological contaminants. Using standalone IP-microstructures, microfluidic fluorometric and electrical/electrochemical sensors are provided. In the sensors, standalone IP films, membranes, or microparticles are integrated for analyte capturing. IP integration is achieved by in-situ light exposure through masks, guided microfabrication through microfluidics, and/or 3D printing based light exposure. The sensing mechanism can include changes in the fluorometric, electrical, or electrochemical signals, upon IP conjugation to target analytes. These can be measured directly using alterations in the fluorescent intensity of the IP microstructures or indirectly using in-situ fabricated electrodes, disintegrated from the IP microstructure.

Embodiments of the present disclosure advantageously allow for in-situ synthesis of standalone IP microstructures encompassing single- and multiplex membranes, as well as nano-particles and micro-particles. These embodiments exhibit exceptional attributes of being both low-cost and scalable, rendering them highly suitable for large-scale mass production. Furthermore, a service platform is provided that significantly enhances the fabrication of tailor-made IP microstructures.

With respect to IP chemistry, composition and polymerization techniques are provided to create standalone IP microstructures with affinity to, for example, ions (e.g., salt ions, lithium, lead, etc.), antibiotics (e.g., azithromycin) and bacteria (E. coli and Salmonella). In a particular case of the present embodiments, more than one solvent (e.g., Dimethyl sulfoxide (DMSO) and Acetonitrile mixture) are used in an IP composition, with fine-tuning the type and amount of FMs, CLs, initiators and solvents to control porosity and minimize shrinkage, and deformation of the bulk IP structure after polymerization (issues that are generally not observed in the case of IP coating). Inhibitors can be used to improve the localized polymerization of IPs within the microfluidic devices, and simultaneous polymerization and immobilization of the IP microstructure within the microfluidic device by creating a covalent bond between the IP microstructure and microchannel walls. This approach enables the IP microstructure to withstand higher flow rates when high-throughput screening is needed. Moreover, integration of nanomaterials such as graphene composites, quantum dots, and MXenes can be used to create smart IP-based microstructures with the ability to be controlled spatiotemporally in the presence of external electric or magnetic fields.

In order to fabricate multicompartmental IP nano- and micro-droplets and membranes, an IP solution preparation is used to control the composition of IP prepolymerization mixtures through sequential or simultaneous dispensing of IP components; i.e., functional monomers (FMs), cross linkers (CLs), initiators (and inhibitors if needed), solvents, and target analytes. Depending on the type of microstructure, different devices may be used, including but not limited to, microfluidic chips, custom-designed 3D printing, and hand-held devices.

Advantageously, the present embodiments provide detectors using IPs that have controllable sizes and shapes and that can be either single flex or multiplex to target one analyte or target more than one analyte.

In this way, the present embodiments overcome the significant problems to high-throughput and precise structuring IP nano- and micro-structures with controlled shapes and sizes that is present in the art. Traditional approaches, like precipitation polymerization for producing standalone IPs are generally limited to creating large agglomerated particles, typically in millimeter scale and larger. These particles can be ground into irregularly sized regolith grains or powders, or formed into singleplex microspheres. However, these approaches lack sufficient control to generate size-controllable and monodispersed particles or multicompartmental microstructures of various shapes, such as microspheres, micropillars, and membranes, necessary for multiplex and sensitive applications. Moreover, IP sensing systems typically involve directly modifying sensing platforms by coating a thin IP film covalently onto transducers. This can include the working electrode in electrochemical sensors, fluorescent microparticles and sheets in colorimetric sensors, and quartz crystal microbalance (QCM) sensors. Yet, IP coating techniques rely on time- and labor-intensive processes to functionalize transducers, requiring additional chemicals for surface modification and potentially resulting in electrode loss after use. The present embodiments can advantageously produce standalone nano- and micro-structures (e.g., nano- and micro-particles, membranes, pillars, and films) with controlled shapes and sizes. This approach can be integrated into microfluidic devices for point-of-need sample preparation and testing as well as developing new sensors with standalone IPs disintegrated from transducers; thereby significantly reducing costs and allowing for the fabrication of IP-based extraction and sensing tools.

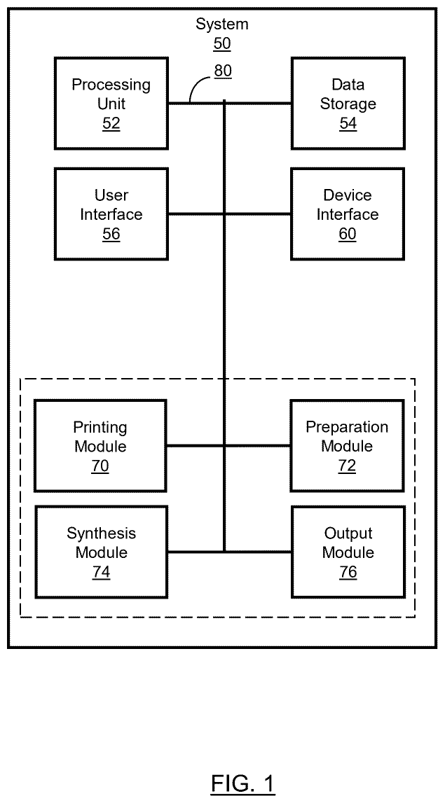

Referring now to FIG. 1, a system 50 for fabricating imprinted polymers for biological or chemical detection using microfluidics, in accordance with an embodiment, is shown. The system 50 can be run on any suitable computing device, for example, on a general-purpose computing device, on a purpose-built controller, or the like. In some embodiments, the components of the system 50 are stored by and executed on a single computer system. In other embodiments, the components of the system 50 are distributed among two or more computer systems that may be locally or remotely distributed.

FIG. 1 shows various physical and logical components of an embodiment of the system 50. As shown, the system 50 has a number of physical and logical components, including a processing unit 52, data storage 54, a user interface 56, a device interface 60 and a local bus 80 enabling the processing unit 52 to communicate with the other components. The processing unit 102 executes various modules, as described herein in greater detail. The data storage 54 provides responsive data storage to the processing unit 52, including computer-executable instructions for implementing the modules, as well as any data used by these services. The user interface 106 enables an administrator or user to provide input via an input device, for example a keyboard and mouse. The user interface 106 can also output information to output devices to the user, such as a display and/or speakers. The device interface 110 permits communication with various computer-controlled equipment and systems that implement the instructions for each module; for example, a UV light source, a heat source, a three-dimensional printer (3D), a mirror-actuator to direct the UV light source, or other types of peripheral devices.

In an embodiment, the processing unit 102 can execute a number of conceptual modules, which can include a printing module 120, a preparation module 122, a synthesis module 124, and an output module 126. In some cases, the functions and/or operations of the conceptual modules can be combined or executed on other modules.

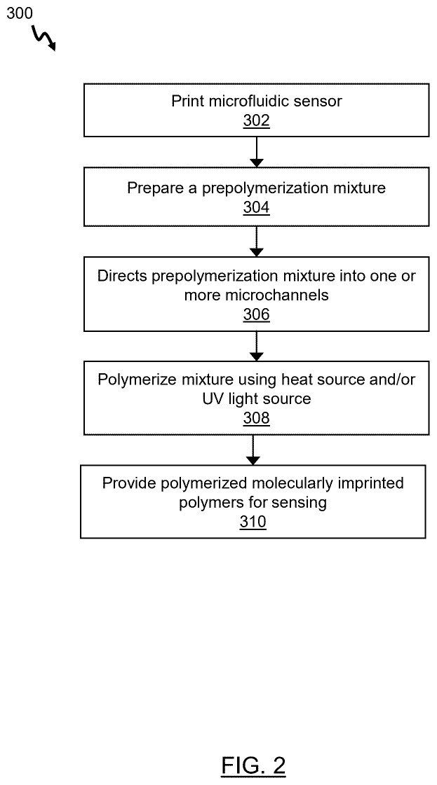

FIG. 2 illustrates a method 300 for fabricating imprinted polymers for biological or chemical detection using microfluidics, in accordance with an embodiment.

At block 302, in some cases, the printing module 70 uses a Stereolithography (SLA) 3D printer to print a microfluidic device from a resin. The resin can then be changed to an IP prepolymer, which can be used to prepare the IP, as described below.

In an example, SLA 3D printers use a localized UV light to cure a prepolymer resin, which after polymerization, forms the structure of the microfluidic device described herein. Any suitable type of curable resins maybe used. Advantageously, the IP prepolymer mixture can be added as a secondary resin to the 3D printing to polymerize the IP microstructure at specific regions within microfluidic chips simultaneously, or sequentially after printing the microfluidic device.

In further cases, the microfluidic device itself can also be 3D printed using fused deposition modelling (FDM), which the IP microstructure can be integrated using SLA 3D printing with the curable prepolymer mixture.

At block 304, the preparation module 72 prepares a prepolymerization mixture by dispensing and mixing of IP components; for example, a target template, functional monomers, crosslinkers, a polymerisation initiator, an inhibitor and/or a solvent. In some cases, where more than one analyte is targeted, a plurality of prepolymerization mixtures can be generated where each prepolymerization mixture includes the respective target template.

When preparing IPs, components of the polymerization mixture generally include monomers, crosslinkers, initiators, and solvents. Selection of the components depends on the nature of the template molecule, ion, or cell and the desired properties of the IP; which the purpose of fabricating a polymer matrix that has high affinity and selectivity for the target via forming a complementary cavity during polymerization.

In a non-limiting example, monomers can include:
Methacrylic acid (MAA),
Methyl methacrylate (MMA),
Acrylamide (AAM), and
N-vinylpyrrolidone (VP)

In a non-limiting example, crosslinkers can include:
Dihydroxyethylene-bisacrylamide (DHEBA),
Ethylene glycol dimethacrylate (EGDMA),
Divinylbenzene (DVB), and
Trimethylolpropane trimethacrylate (TRIM).

In a non-limiting example, initiators can include:
Azobisisobutyronitrile (AIBN),
Benzoyl peroxide (BPO), and
2,2′-Azobis(2-methylpropionamide), dihydrochloride (AIBA).

In a non-limiting example, solvents can include:
Toluene,
Acetonitrile,
Methanol, and
Dichloromethane (DCM).

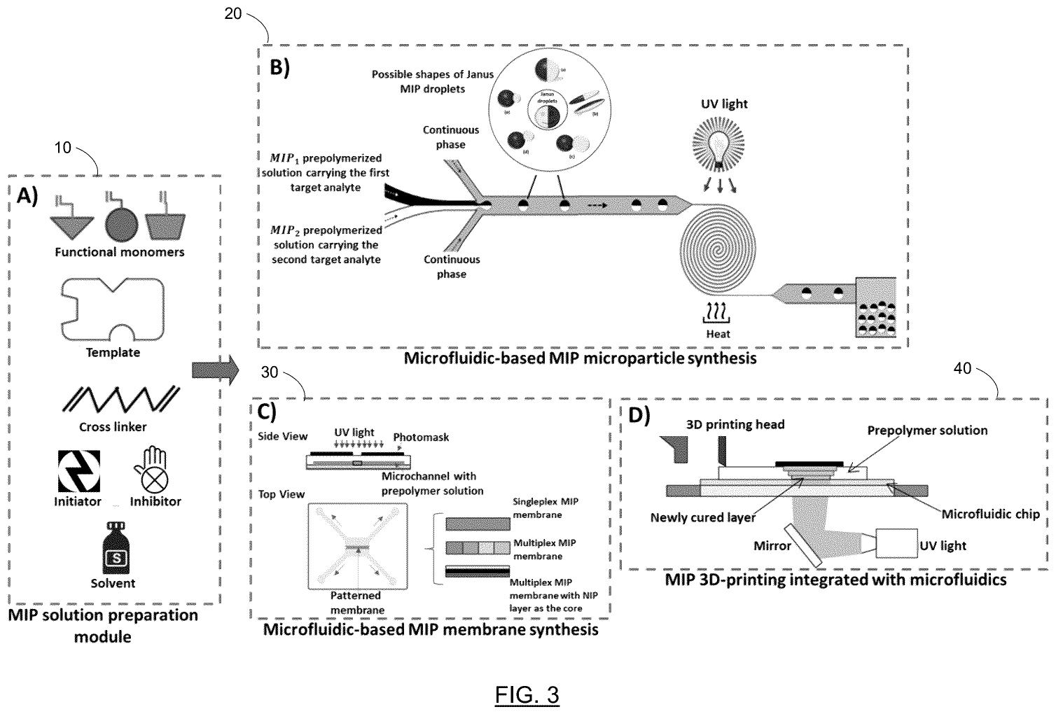

At block 306, the synthesis module 74 directs the prepolymerization mixture into one or more microchannels. As illustrated in the example of FIG. 3, in some cases, where more than one analyte is targeted, each respective prepolymerization mixture is directed to a separate input microchannel, after which the microchannels merge or converge at a downstream microchannel, such as at a central chamber. Depending on the prepolymer mixture and its properties, the choice of continuous phase can be different. For example, different concentrations of Polyvinyl alcohol (PVA), fluorinated oil, mineral oil, Dionized (DI) water, or the like.

At block 308, while the generated droplets traverse a microchannel, the synthesis module 74 directs a light source (e.g., an ultraviolet (UV) light source) and/or a heat source at the microchannel with the droplets traversing therein. The light and/or heat source polymerizes the droplets heat to solidify the microparticles of the droplet into IPs. The microchannel can have any suitable shape, for example, having a spiralized shape.

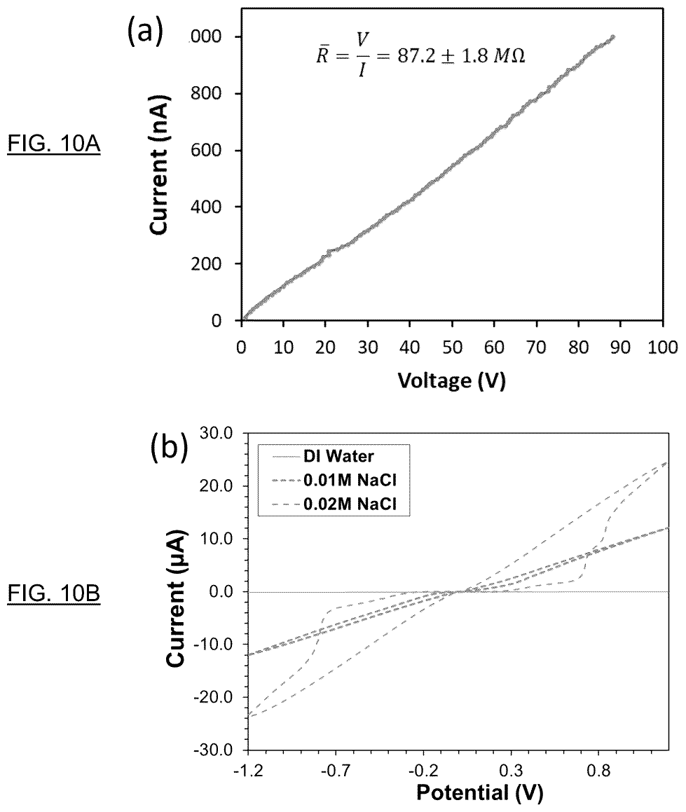

In further cases, the light and/or heat source can be directed at a patterned membrane located between a pair of inlet microchannels and outlet microchannels; as described in greater detail with respect to FIG. 9. In a particular case, a UV light photomask can be situated between the UV light source and the membrane. In such cases, the synthesis module 74 can locally polymerize areas of the prepolymerization mixture based on areas exposed to the UV light source through the mask Such localized polymerization permits efficient and highly-regulated control of the shapes and sizes. Such precise control of sizes ultimately enables users to capture small amounts of target analytes present in a sample. Additionally, this approach permits the creation of relatively small-dimension micro features that can be specific to various target analytes to ultimately improve sensitivity or specificity towards a particular target.

At block 310, the output module 76 provides the IPs for capturing or detecting the biological or chemical substances. In some cases, such as where the IPs are droplets or particles (droplets that have been then subject to curing), the polymerized IPs can be outputted to any suitable receptacle. In other cases, such as where the Ips are membranes or pillars, the IPs in the microfluidic device can be converted into a sensor for detecting chemical or biological material; for example, by attaching electrodes in a housing with the microfluidic device to form an electrochemical sensor.

FIG. 3 illustrates a diagram of an example implementation of the approaches of the present embodiments for fabricating microstructures of IPs for biological and chemical sensing applications. At block 10, IP solution preparation module is provided for developing an IP prepolymerization mixture through dispensing and mixing of the IP components. At block 20, a microfluidic-based complex IP microparticle synthesis module is provided. At block 30, microfluidic-based IP membrane synthesis module is provided. At block 40, IP 3D-printing integrated with microfluidics module is provided.

At block 20, a droplet microfluidic device, as described herein, can be fabricated with microchannels for high-throughput generation of homogenous and multicompartmental (Janus and tertiary) IP droplets. These devices can consist of two main modules, a droplet generator and a micro-reactor.

After preparing the IP prepolymerization mixture, the droplet generator can be used to generate discrete IP nano- and micro-droplets using immiscible multiphase flow in microchannels. Different shapes of droplets can be generated, including but not limited to, Janus, tertiary, core-shell droplets and nano- and micro-capsules. Different target analytes might be added to IP composition either in the upstream IP solution preparation module or after formation of the non-imprinted polymeric (NIP) droplets using separate microchannels located before the micro-reactor module.

The micro-reactor can be used to maximize surface area and residence time of the droplets in a small space for thermal, photo, or photothermal polymerization of IP droplets using heat, UV light, or a combination of both. The microchannel design might include long spiral, serpentine, meandering, zigzag, wavy, and tree-like shapes. It should be mentioned that another micro-heat exchanger can be considered upstream the droplet generator to preheat the continues immiscible phases so that the viscosity of the continuous phase does not change due to the temperature gradient along the channel; thereby, keeping the droplets distinct from each other and from the channel walls. The previous challenges regarding the adhesion of the microdroplets (or partially cured microparticles) to each other or to the microchannel walls can be addressed by applying coatings on microchannel walls or using specific fluids as C-phase (e.g., polyvinyl alcohol (PVA)). By utilizing pressure pumps to maintain a constant pressure inside the microchannels, as opposed to syringe pumps that maintain constant flow rates, the quality of droplet generation can be enhanced.

Another approach for creating homogenous or multi-compartmental IP droplets is capillary pressure microinjection (CPM) of IP prepolymerization mixture in a hot immiscible surrounding liquid. A pressure-driven flow (PDF) system can be used to generate controlled pressure pulses at the tip of microneedles filled with IP prepolymerization solution. By applying short pulses (few milliseconds), high-throughput droplet generation is enabled. Multi-capillary tubes filled with different types of IPs can be connected to the pressure source to generate single droplets and multicompartmental (Janus and tertiary) IP droplets. Generated droplets can be separated from the needle tip due to gravity and quickly cured in the hot immiscible surrounding liquid.

A microfluidic chip, which can be used as the biological or chemical sensor, can also be used to create the IP membrane in the microfluidic-based IP membrane synthesis module 30. The microchannel network can include X-shaped crossflow microchannels and a central chamber; for example, CNC micro-milled in PMMA sheets and bonded to a polycarbonate substrate using a transparent double-sided tape. The microfluidic chip can be filled by the IP prepolymerization solution. Then, a photomask can be applied on top of the microfluidic chip to polymerize only specific regions of the channel and form the first part of the IP membrane. After localized curing of the first section of the IP membrane, the remaining uncured solution can be removed, and the chip can be filled with the second type of IP solution. Another mask can be applied to cure the second part of a membrane. This approach can be used to generate a single membrane or repeated to generate a multicompartmental membrane. Alternatively, the approach can start by localized photopolymerization of a core non-imprinted polymer (NIP) membrane and then polymerizing thin IP layers covering the core NIP; which does not produce buried analyte imprints. The same approach can be used for generating 2D IP by spreading IP solutions on a flat substrate or networks of shallow microchannels. After polymerization of the standalone IP membrane, such a device could be converted to a sensor by attaching the microfluidic device with electrodes manufactured directly on chip to form a sensor. Electrodes can also be made by injecting conductive pastes into designated microchannels. Small pillars can be used at the junction of the main chamber and side electrode microchannels to stop the advancing menisci. Then, the electrodes can be thermally cured in an oven.

Integration of microsensors and 3D printed IP microstructures can be used to form multicompartmental 2D IP patches and 3D microstructures (e.g., membranes, micropillars) by 3D printing both the microsensor from a first resin and the IP microstructures from a second IP prepolymer. In an example, a 3D printer, such as a Stereolithography (SLA) 3D printer, can be used to print a microfluidic sensor from the resin, then the resin can be changed to the IP prepolymer and the approach for 3D UV based printing through a CAD mask can be continued to make IP membranes and micropillars, using the IP 3D-printing integrated with microfluidics module 40. The polymerization is completed after printing using heat or UV light. This approach can be performed within microfluidic chips as in-situ polymerization can make very complex microsensors with sophisticated embedded IP microstructures. A particular advantage is the suitability to integrate various IP compositions and structures into the sensor for detection of multiple targets or performing high throughput microarray sensing.

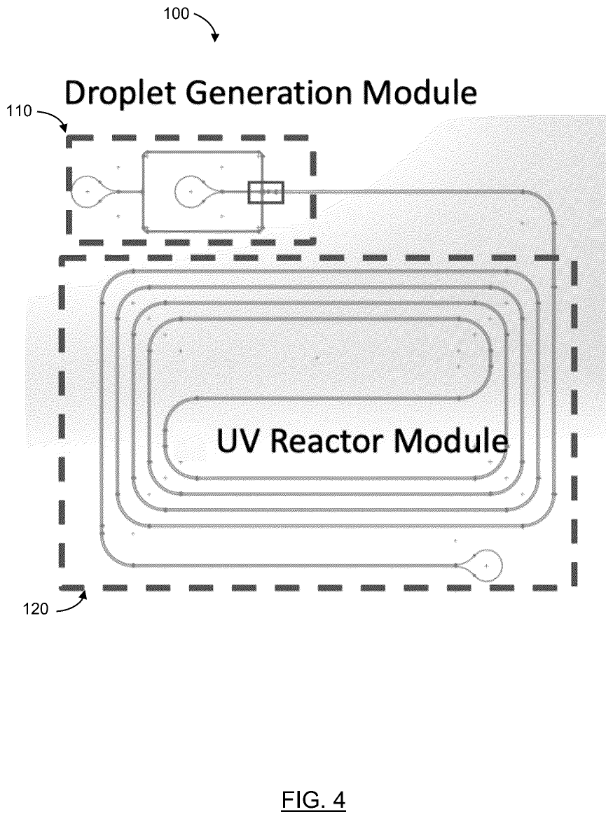

FIG. 4 illustrates a microfluidic device 100 in accordance with a particular embodiment. The microfluidic device 100 includes a flow-focusing droplet generator module 110 and a microreactor module 120 that is used to cure CIP droplets using UV light (e.g., 365 nm). In this case, the microreactor module 120 has a spiral shape, however, any suitable shape can be used, such as zigzag, serpentine, or other shape. In this particular case, the microfluidic device 100 can generate and polymerize monodisperse microdroplets of cell imprinted polymers (CIPs) with control over particle size and frequency. CIPs are synthetic receptors that can selectively recognize and bind target cells based on their physiochemical characteristics. They provide a cost-effective and more stable alternative to natural receptors like enzymes and antibodies. Traditional polymerization approaches for imprinted polymers including bulk, suspension, and precipitation polymerization lack control over the particles' morphology, leading to powders, or large beads (>few millimeters) with buried binding sites. To overcome these limitations, the microfluidic device 100 includes microfluidic droplet generation. The microfluidic device 100 controls convergence of two fluid streams through a narrow channel. The first stream is called a continuous phase (C-phase) and the second stream is called a dispersed phase (D-phase). The C-phase squeezes the D-phase, breaking it into uniform droplets. The microfluidic device 100 optimizes C-phase and D-phase composition, channel design, flow rates, and photopolymerization parameters, enabling the generation of monodisperse non-imprinted (NIP) and bacteria-imprinted (CIP) microparticles.

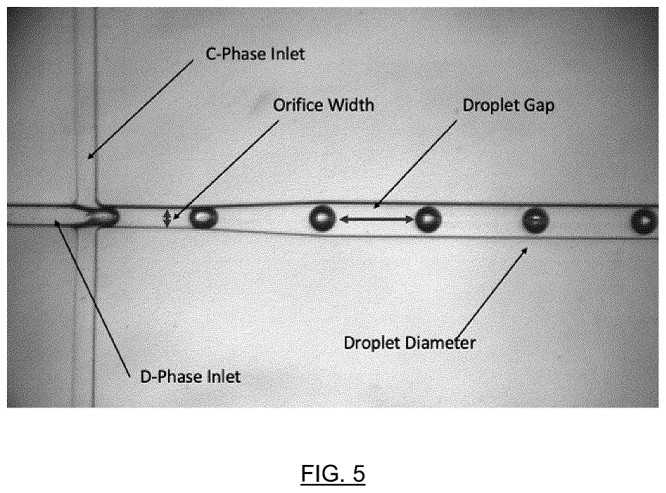

In an example, a prepolymer mixture and Poly (Vinyl) Alcohol (PVA) can serve as D-phase and C-phase, respectively. In an example, the microfluidic device 100 can be made of polydimethylsiloxane (PDMS) through standard soft lithography using master molds fabricated by 3D-Printing (for microparticles >200 μm) or photolithography (for microparticles <200 μm). The C-phase can flow from two directions, pinching the D-phase to form microdroplets; as illustrated in FIG. 5. FIG. 5 is a microscopic image of microfluidic NIP droplet generation with various parameters visualized.

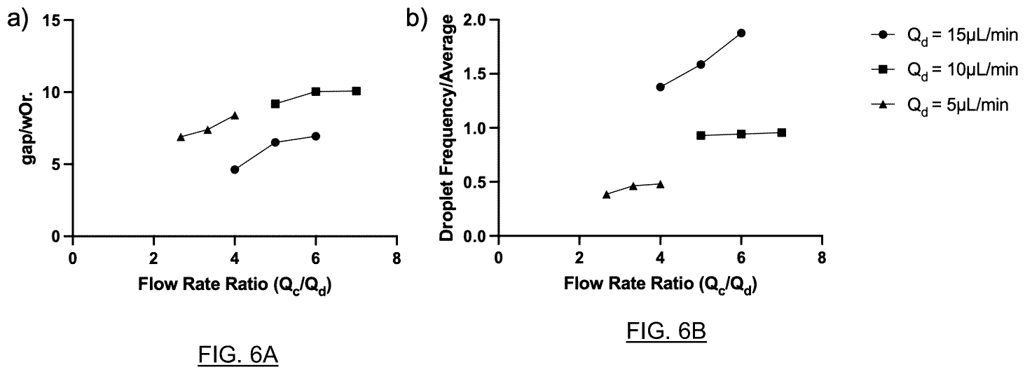

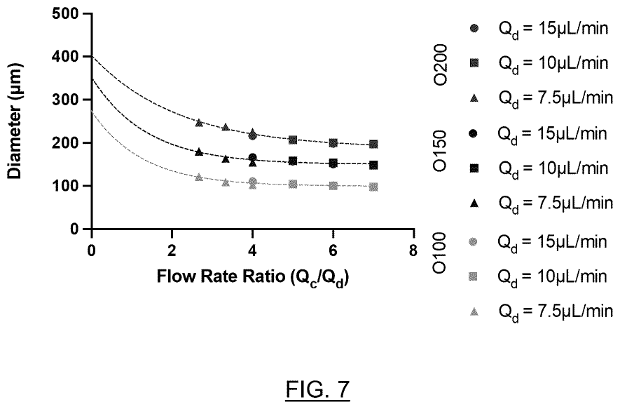

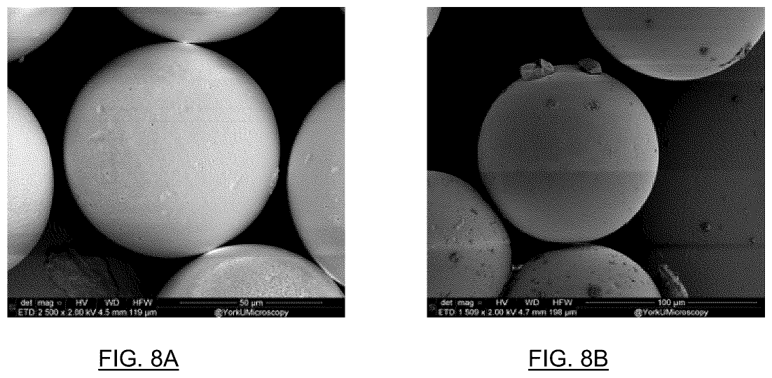

In example experiments, increasing the flow rate ratio, particularly at Q_{d}<10 L/min, increased spacing between droplets (FIGS. 6A and 6B) and decreased diameter (FIG. 7). These conditions optimize on-chip polymerization, preventing aggregation and device clogging. Narrowing orifice width achieved smaller droplet sizes (FIGS. 6A and 6B). The smallest orifice width of 100 μm produced the smallest droplets, illustrating a direct relationship between orifice width and droplet size. Optimal flow rate ratio was dependent on the fixed Q_{d}. At higher Q_{d}, higher flow rate ratios could be maintained as backflow was prevented by increased pressure from the D-Phase inlet. FIG. 6A is a chart illustrating normalized droplet gap by orifice versus flow rate ratio for device O200. FIG. 6B is a chart illustrating normalized frequency by average frequency for all trials versus flow rate ratio of device O200. FIG. 7 is a chart showing a comparison of droplet diameter versus flow rate ratio for various tested devices.

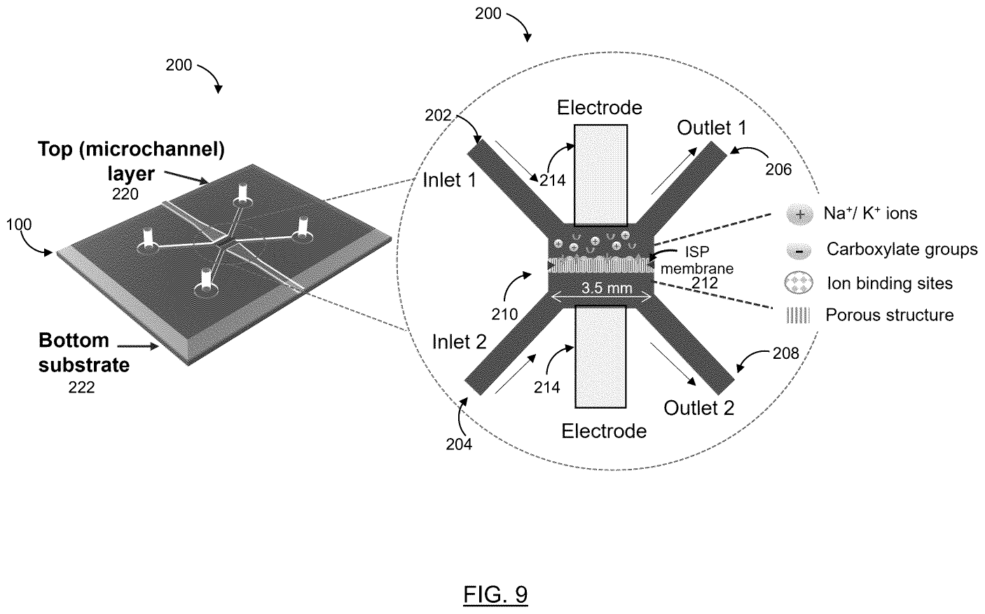

In the example experiments, NIP droplets (50 μm-200 μm diameter) were successfully synthesized. A Scanning Electron Microscopy (SEM) demonstrated a uniform, smooth, surface morphology for NIP microparticles, illustrated for unwashed particles in FIG. 8A and washed particles in FIG. 8B.

The present inventors conducted example experiments to verify the substantial advantages of the present embodiments. The present inventors have demonstrated fabrication of monodispersed IP microspheres using microfluidic droplet generation followed by in-situ UV polymerization for non-imprinted polymeric (NIP) microspheres and bacteria cell (CIP) and lithium ion imprinted microparticles with controlled sizes in the range of nanometers to millimetres in diameter. Different solutions for continuous phase (C-Phase) and dispersed phases (D-phase) were tested and flow rates were characterized. Surface morphology and size distribution were characterized using optical and Scanning Electron Microscopy (SEM). The example experiments showed that the present embodiments addressed challenges in microfluidic-based IP droplet generation and polymerization with respect to alterations in continuous phase's fluid properties (e.g., viscosity, and density) during thermal- or photo-polymerization (which affect the interdroplet spacing and may cause particle agglomeration and clogging the microchannels), adhesion of microparticles during polymerization to microchannels walls, and proper collection of microdroplets from the outlet without affecting their shapes. Particularly, the example experiments showed that these challenges were addressed through the microchannel designs, use of unconventional chemicals in prepolymer solution (D-phase) and C-Phase, optimizing flow rates, and applying coatings into channel walls.

Additionally, in the example experiments, thickness controlled IP-membranes were in-situ fabricated in a low-cost microfluidic device consisting of X-shaped crossflow microchannels, and a central chamber with an IP membrane in-situ photopolymerized in the center. NIP membranes of different widths (100-600 μm) were photopolymerized in-situ. Membrane deformability and bond strength to chamber walls were evaluated at different flow rates in the channel (0-1 mL/min). A strong bond between the NIP membrane, and microchannel walls was achieved, preventing leakage through the interface of the NIP membrane and chamber walls. Membranes imprinted with bacteria and different salt ions (NaCl, KCL, etc), were successfully made and characterized with the present embodiments. Moreover, the microfluidic device of the present embodiments was equipped with two low-cost electrodes, converting it into an electrochemical sensor. The application of the IP membrane integrated microfluidic sensor for low limit salinity measurement was demonstrated. Briefly, when compared with a membrane-less sensor, the ISP membrane-integrated device showcased a 44% decrease in the limit of detection (LOD) from 0.25 ppm to 0.14 ppm, an 73% reduction in the limit of quantification (LOQ) from 0.95 ppm to 0.16 ppm and increase in sensitivity from 0.00064 (μ·A/ppm) to 0.0024 (μ·A/ppm). The sensor performance was further improved when incorporating the Na⁺-imprinted polymer (Na⁺-IP) membrane such that the Na⁺-IP sensor demonstrated a LOD of 0.058 ppm, a LOQ of 0.19 ppm and a sensitivity of 0.0091 μA/ppm within the 0-100 ppm range. Moreover, the sensor showed a high level of specificity to the imprinted ion (Na⁺) when compared to other salt ions. The sensor of the present embodiments achieves substantially low detection and quantification limits, surpassing other approaches.

FIG. 9 illustrates an embodiment of a microfluidic device 200 for detection or measurement of a target analyte; the target analyte comprising a molecule, ion, or cell. The microfluidic device 200 can include a first inlet 202, a second inlet 204, a first outlet 206, a second outlet 208, a central chamber housing 210 with a membrane 212 therein, and electrodes 214. The membrane 212 includes an imprinted polymer fabricated using a prepolymerization mixture comprising a target template for the target analyte. The electrodes 214 are integrated in the housing and are in communication with the membrane 212 to form an electrochemical sensor.

In the embodiment of FIG. 9, the microfluidic device 200 generally has a butterfly shape with the membrane 212 located at the center; however, any suitable channel arrangement and shape can be used to direct the prepolymerization solution to the membrane for polymerization.

In an example, the microfluidic device 200 can be used to measure water salinity. Water salinity measurement is generally critical in water quality monitoring, human health, and environmental preservation. For drinking water, a sodium concentration above 200 mg/L is offensive in taste, while concentrations should ideally not exceed 20 ppm to align with dietary guidelines. However, water salinity monitoring, especially at concentrations below 100 ppm, is technologically limited. Generally, the specificity characteristics of sensors typically involve modifying transducers with recognition elements, necessitating complex, time-and-cost intensive processes. In contrast, the microfluidic device 200 enables in-situ fabrication of a standalone ion-selective membrane (ISP) 212 in a microfluidic device; which is disintegrated from the electrodes and functions independently, addressing the specificity and sensitivity challenges for salt ion detection.

Several approaches exist for measuring water salinity, with electrical conductivity measurement being the most prevalent. However, many of these techniques are tailored for monitoring high salinity levels typical of seawater, in the range of 2-42 PSU (2000-40,000 ppm), with a general standard of 35 PSU. Several optical techniques, including fiber optics-based methods, and interferometry, have been proposed as alternatives but are complex and expensive due to additional opto-electronic components. Moreover, their popular reliance on refractive index changes lacks precision for salinity quantification, especially at drinking water scale.

The microfluidic device 100, 200 advantageously allows for cost-effective mass production of compact salinity sensors suitable for field deployment, offering fast reaction times, increased sensitivity, and low detection limits. The high surface area-to-volume ratio and short diffusion distance contribute to these advantages. In view of the importance of low-level salinity measurement in drinking water and the desire for a simple portable low-cost sensor, the microfluidic device 100, 200 integrates the ion-selective polymeric (ISP) or IP membrane 212 for the detection of salt concentrations and type at low limits ($200 ppm), as crucial to drinking water salinity monitoring. The integrated free-standing membrane 212 eliminates the cost-and-time-intensive electrode surface pre-treatment and modification steps peculiar to existing ISE sensors, and acts as a selective concentration of salt ions of interest in the microsensor chamber, thereby amplifying electrochemical response at low concentrations. The electrochemical approach provides real-time monitoring capabilities, making the microfluidic device 100, 200 suitable for continuous assessment in water treatment plants and distribution systems.

The microfluidic device 100, 200 illustrated in FIG. 9 comprises an X-shaped fluid-handling module, which includes a central chamber 210 housing the IP membrane 212, and a pair of inlet 202, 204 and outlet 206, 208 microchannels on either side of the membrane. The microfluidic device 100, 200 further includes two silver electrodes 214 fabricated in designated microchannels in-situ at the two sides of the ISP membrane 212. The central chamber 210 (for example, with dimensions of 3.5×3.0 mm²) was designed to accommodate the stand-alone membrane 212 that will form a semi-permeable barrier between parallel flowing streams in the side channels, facilitating optimal sample-membrane interaction. Two small anchoring structures were considered within the chamber, at the two ends of the membrane 212. These anchors enhanced the structural stability of the membrane, ensuring its secure attachment to the chamber walls.

The microfluidic device 100 implemented for the microfluidic device 100, 200 includes two layers: a top layer 220 housing the above described microchannel networks, and a sealing bottom layer 222. The layers can form a housing for the electrochemical sensor described herein. For the top layer, in an example, microchannels can be milled into a Polydimethlymethacrylate (PMMA) substrates to a depth of 200 μm using a CNC machine. PMMA can be used as the chip material due to its durability, optical clarity, UV transparency, suitability for mass production, and chemical compatibility with the ISP membrane composition and synthesis. The PMMA layer can be adhered to another blank substrate like PMMA r polycarbonate substrate using a clear double-sided tape or compression bonding, followed by clamping the chip for 5 minutes to ensure effective adhesion of components. The electrodes 214 and the ISP membrane 212 can then be equipped to the microfluidic device 100, 200.

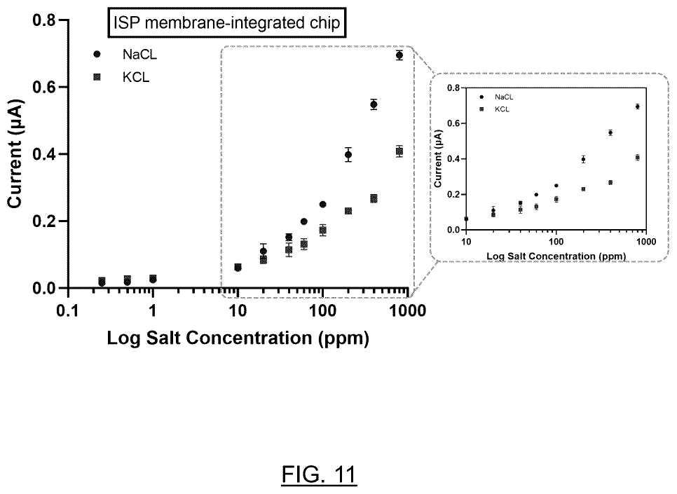

The central chamber housing 210 of the microfluidic device 100, 200 incorporates the UV-curable, thickness-controlled ISP membrane 212 and a synthetic receptor, both within the polymethacrylate (PMMA)-based microfluidic device 100. Carboxylic and amide functional groups-based monomers present in ISP membrane's composition are responsible for ion-exchange with sample solutions, allowing the membrane to selectively concentrate salt ions of interest; thereby enhancing sensitivity and selectivity. This approach enhances the electrochemical signal measured by the two adjacent electrodes 214. In an example, the electrodes 214 can be in-situ fabricated inexpensively by injecting conductive pastes like silver paste into designated microchannels, followed by thermal curing (75° C., 24 hrs). An investigation by the present inventors into the chemical stability of these electrodes 214 revealed a strong linear correlation between input voltage and output current in linear sweep voltammetry tests (FIG. 10A) and no electrode oxidation in cyclic voltammetry tests (FIG. 10B). FIGS. 10A and 10B are charts showing electrode stability where FIG. 10A shows a V-I curve showing a linear correlation between applied voltage and current output, and FIG. 10B shows cyclic voltammetry (CV) showing no electrode oxidation.

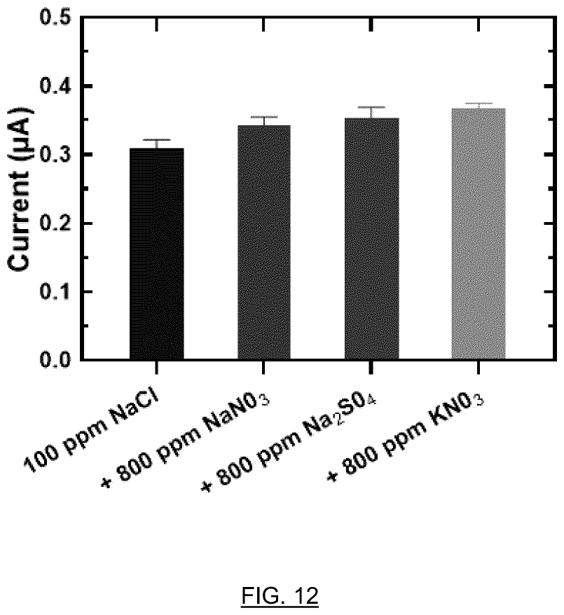

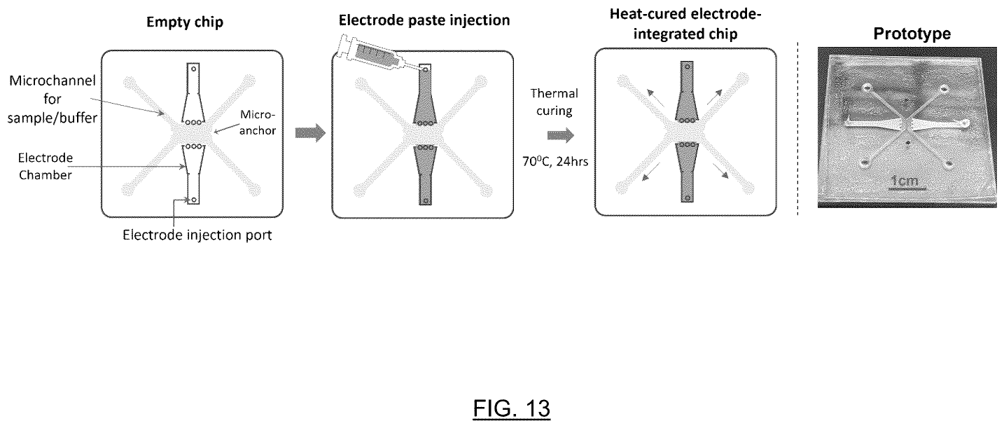

Chronoamperometry measurement performed by the microfluidic device 100, 200 enabled accurate NaCl detection within 1-800 ppm according to example experiments. In the example experiments, the sensor's 200 performance was assessed, and the sensor dose-response curves were obtained without the membrane, with the ISP membrane, and with the IP membrane. Incorporating the ISP membrane led to a 44% decrease in the limit of detection (LOD) from 0.25 to 0.14 ppm, an 83% reduction in the limit of quantification (LOQ) from 0.95 to 0.16 ppm, and an increase in sensitivity from 0.0064 μA/ppm to 0.0024 μA/ppm. The sensor performance was further improved when incorporating the Na⁺-imprinted polymer (Na⁺-IP) membrane such that the Na⁺-IP sensor demonstrated a LOD of 0.058 ppm, a LOQ of 0.19 ppm and a sensitivity of 0.0091 μA/ppm within the 0-100 ppm range. Moreover, the sensor showed a high level of specificity to the imprinted ion (Na⁺) when compared to other salt ions. In the example experiments, the sensor's 200 selectivity was rigorously evaluated, demonstrating a capability to differentiate between K⁺ and Na⁺ ions. With the ISP membrane in place, a sensitivity ratio of 1.75 to 1 for Na⁺ over K⁺ was achieved, compared to a ratio of 0.73 to 1 without the membrane (FIG. 11). FIG. 11 is a chart showing the microfluidic device's 200 sensitivity to Nacl and Kcl salts. In addition, interference studies involving the detection of 100 ppm NaCl in the presence of commonly interfering ions including sodium nitrate (NaNO₃), potassium nitrate (KNO₃) and sodium sulfate (Na₂SO₄) revealed minimal interference, with peak variations of only 10.5%, 13.6%, and 18.4% respectively, demonstrating the sensor's potential in complex matrices (FIG. 12). FIG. 12 is a chart showing the effect of sodium nitrate, sulphate, and potassium ions on the detection of 100 ppm of NaCl.

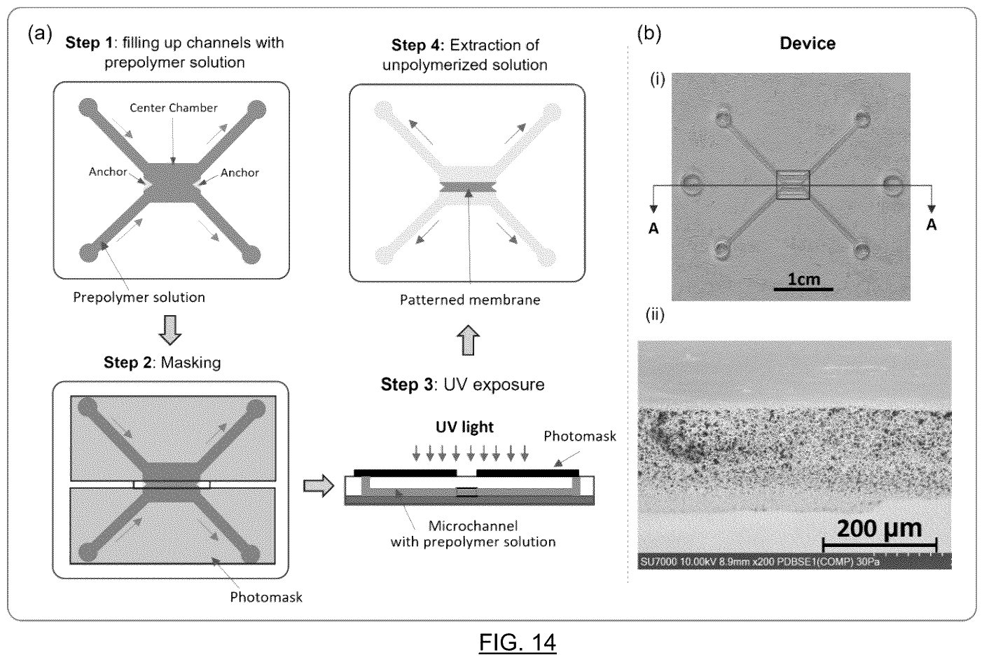

An example of in-situ fabrication of the electrodes 214 of the microfluidic device 200 is illustrated in FIG. 13. It commenced with manually injecting DuPont™ 5025 silver conductor paste into specified funnel-shaped microchannels through injection ports. Micropillars, 30 μm in diameter and spaced 50 μm apart at the electrode channel junction with the main chamber, served to block the paste from entering the central microchamber during injection and maintained its position during the curing process. Subsequently, the device underwent a thermal curing process in an oven set at 70° C. for a duration of 24 hours.

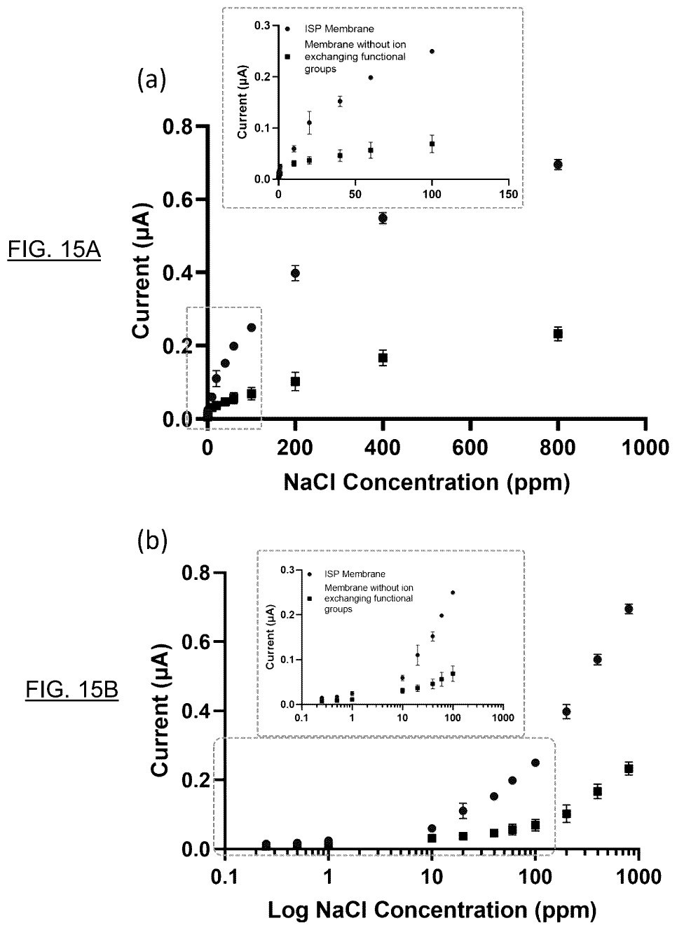

An example of fabrication of the Ion-Selective Polymeric (ISP) membrane 212 is illustrated in FIG. 14. The fabrication involves selecting and integrating specific monomers, cross-linkers, porogens, and inhibitors to achieve desired membrane properties. The prepolymer solution, in this example, comprises four key monomers: Acrylamide (AAM), Methacrylic Acid (MAA), N-Vinyl Pyrrolidone (NVP), and Methacrylate Acid (MMA). Additionally, a cross-linker (Ethylene Glycol Dimethacrylate—EGDMA), a photo-initiator (2,2-Dimethoxy-2-Phenyl-Acetophenone—DMPA), and binary porogens (Dimethyl Sulfoxide-DMSO and Acetonitrile) can be included in the solution, with a monomer:crosslinker:solvent molar ratio of 1:1.2:12.3. Additionally, hydroquinone, a polymerization inhibitor, can also be added to curb undesired polymerization outside the exposed region, which could occur due to molecular diffusion or heat.

Each component in the prepolymer solution enhances the functionality and structural integrity of the ISP membrane 212. MAA, with carboxylic acid groups (—COOH), ionizes in aqueous solutions, forming negatively charged carboxylate ions (—COO—) that act as ion exchangers, facilitating electrostatic interactions with desired cations. MMA, a hydrophobic monomer, provides structural support to the polymer matrix, enhancing mechanical strength and stability. NVP, a hydrophilic monomer, improves water absorption and swelling properties, promoting interactions with water ions for facilitated ion transport. AAM contributes to the overall structure and stability of the polymer matrix, with its amide group (—CONH₂) influencing ionic interactions within the membrane 212.

The example localized in-situ photopolymerization fabrication, depicted in FIG. 14, can commence by injecting the prepolymer solution into the channels to completely fill the chamber. Subsequently, a precisely aligned shadow mask can be positioned on the microfluidic device 100, exposing only the desired membrane thickness to UV light. The microfluidic device 100, with the mask in place, can then be positioned beneath a UV light source (e.g., emitting at 365 nm wavelength, with an intensity of 15 mW/cm²). After a 5-minute exposure to UV light, any remaining unpolymerized solution in the chamber can be carefully extracted using a syringe. A second 2-hour exposure can then be conducted to ensure thorough polymerization of the membrane. Upon completion of the photopatterning, the microfluidic device 100 can undergo rinsing with water to eliminate residual unreacted components. FIG. 14 includes a photograph of a fabricated microchannel device and an SEM image of its cross-section displaying the ISP membrane 212 securely bonded to the channel walls.

An example experimental setup includes a syringe pump to deliver the samples with a controlled flow rate into the microfluidic sensor positioned under an upright microscope, with outlets connected to a waste reservoir. A potentiostat was on one side connected to the electrode ends on the microsensor, and on the other side linked to a computer to control and record electrical signals in the sensor.

In example experiments of the microfluidic device 100, 200, two salt samples, NaCl and KCl, with concentrations ranging from 0.25 to 800 ppm, were dissolved in DI water. The samples were prepared by initially dissolving 160 mg of NaCl or KCl in 200 ml of DI water to create a solution of 800 mg/ml (ppm) of saltwater. Through serial dilution with DI water, maintaining a constant dilution factor, concentrations of 400, 200, 100, 80, 60, 40, 20, 10, 5, 1, 0.5, and 0.25 ppm of NaCl were prepared and employed in the experiments. The samples were introduced into the microchannels via a syringe pump at a flow rate of 400 L/min for each inlet, summing up to a total flow rate of 800 μL/min (Qₜₒₜₐₗ=Qᵢₙₗₑₜ₁+Qᵢₙₗₑₜ₂).

The present inventors determined that the ISP membrane-integrated microfluidic device 100, 200 has improved performance due to, at least, the presence of ion-exchanging functional groups within the composition of the ISP membrane 212 and their interaction with salt ions. To exemplify this, the present inventors conducted a control experiment involving the synthesis of a membrane without the functional monomers (i.e., MAA and AAM), which contribute the carboxylic acid and amide functional groups, respectively. The results, encompassing measurements within the same 0-800 ppm NaCl concentration range revealed a stark difference in the response of the sensors. Additionally, the present inventors conducted a control experiment involving non-imprinted polymer (NIP) membrane lacking the Na⁺ specific binding sites and compared it with the Na⁺-imprinted polymer (Na⁺-IP) membrane, across a range of NaCl concentrations from 0.25 to 1000 ppm. Results demonstrated a significant improvement in the sensor's parameters in Na⁺-IP membrane compared to NIP membrane sensor or compared to a sensor without any membrane.

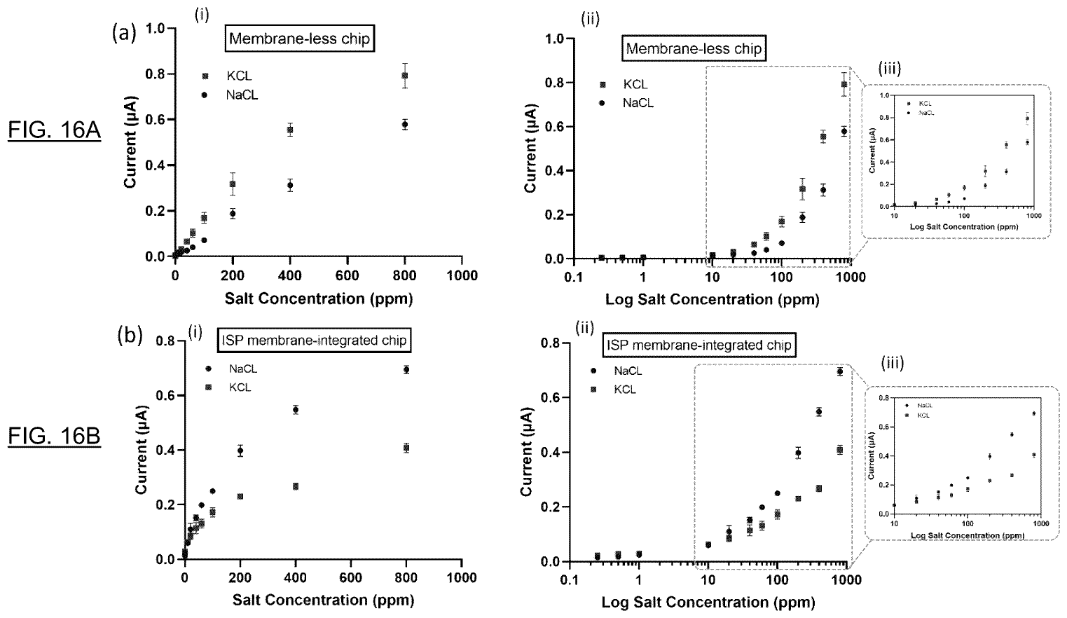

FIGS. 15A and 15B are charts illustrating dose-response curves for the ISP membrane-integrated sensor and the sensor with the membrane lacking the ion-exchanging monomers. FIG. 15A shows a linear plot and FIG. 15B shows a semi-log plot. Experiments were conducted at a flow rate of 800 μl/min with each sample tested three times in three replicate devices. Error bars represent standard deviation (SD). As depicted in FIGS. 15A and 15B, the sensor with a membrane lacking the ion-exchanging monomers exhibited a low current response profile, indicating inferior sensitivity compared to its functional monomer-integrated counterpart. This substantial difference in sensitivity is evident from the steeper slope and greater current response of the ISP membrane-integrated sensor across the entire concentration range. To be precise, the ISP membrane-integrated sensor's sensitivity measured at 0.0024 μA/ppm, significantly surpassed the 0.00064 μA/ppm sensitivity of the sensor without the functional groups, showcasing an enhancement of ˜ 270% in sensitivity. Moreover, the presence of ion-exchanging functional monomers in the membrane composition moderately enhanced the sensor's LOD and LOQ. The sensor with a membrane lacking the functional groups exhibited an LOD and LOQ of 0.16 ppm and 0.95 ppm, respectively, which were 12.5% and 73.7% lower than those of the ISP membrane-integrated device.

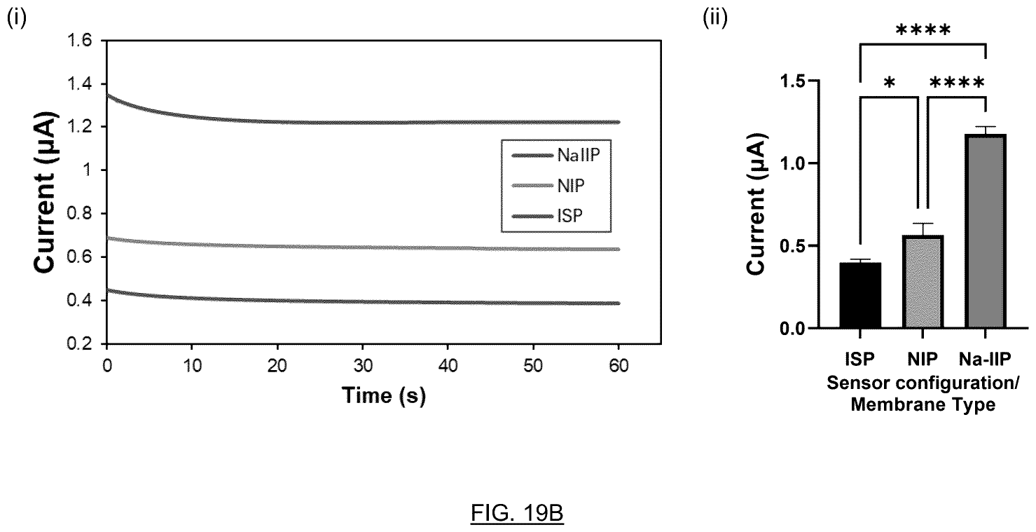

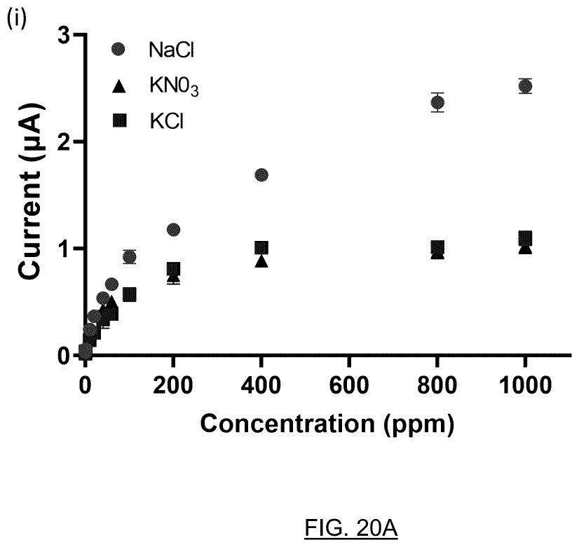

Inventors compared two sensor configurations: one with a non-imprinted polymer (NIP) and the other with the Na⁺-IP, across a range of NaCl concentrations from 0.25 to 1000 ppm. The chronoamperometry response for each concentration was measured at an optimized flow rate of 400 μL/min. Each test was conducted using three replicate devices, each tested three times to ensure consistency and repeatability. Based on the dose-response curves (FIG. 19A), the Na⁺-IP sensor demonstrated a LOD of 0.058 ppm and a LOQ of 0.19 ppm, with a sensitivity of 0.0091 μA/ppm within the 0-100 ppm range. In comparison, the NIP sensor exhibited a LOD of 0.17 ppm (193% higher), an LOQ of 0.92 ppm (384% higher), and a sensitivity of 0.0035 μA/ppm (62% lower) within the same range.

Advantageously, the microfluidic device 200 separates the ISP membrane 212 from the electrodes 214, in contrast to other approaches to sensors, allowing the membrane 212 to be independently fabricated and function without the need for surface treatments; while maintaining a high level of sensitivity, thereby addressing challenges typically found in ion selective electrodes. Additionally, prior research predominantly focused on analyzing salinity within the sea water range. These approaches often suffered from elevated LODs and inefficiency in low salinity levels (≤200 ppm), along with the complexity and labor-intensive nature of their fabrication processes. In contrast, the microfluidic device 200 broadens the application spectrum for ISP membranes and can be used in a wider range of environmental monitoring applications.

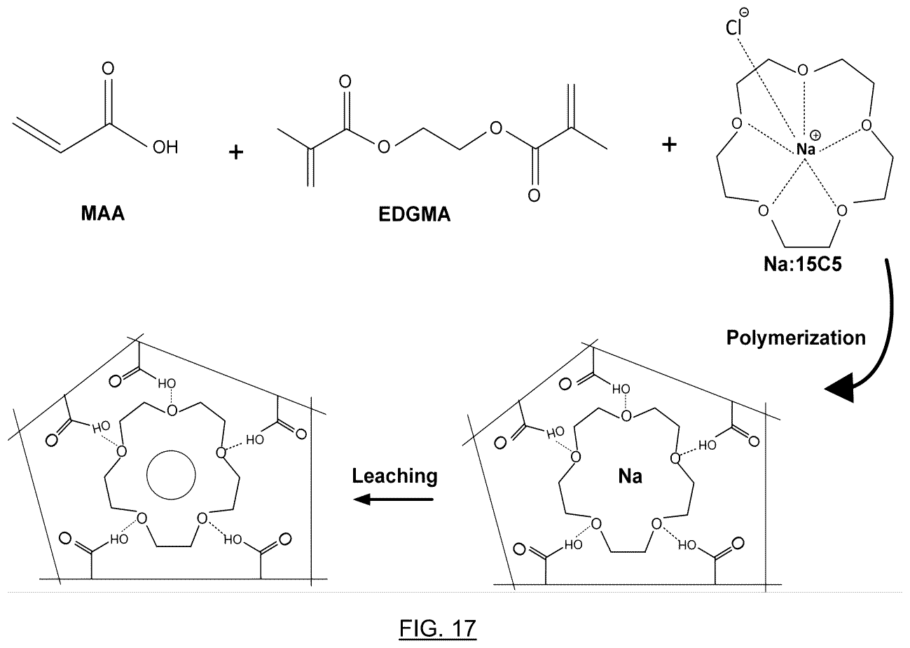

To further highlight the robustness of the microfluidic device 100, 200, the example experiments explored the device's 100, 200 capability to distinguish between different salt types. To this end, two closely related salt elements, K+ and Na+, were used, taking into account their inherent mobility differences. Two microfluidic device 200 configurations were used; i.e., the membrane-less device 100, where detection primarily relies on ion transport to the electrode surface, and the ISP membrane-integrated device 200, where the membrane 212, owing to its functional group charge, interacts with the sample and concentrates counter ions, thereby enhancing the transmembrane signal. Membranes 212 containing carboxylate functional groups have been demonstrated to exhibit preferential selectivity towards Na+ and K+ ions. In the experiments, KCl and NaCl samples were examined across concentrations ranging from 0.25 to 800 ppm, maintaining a consistent optimal flow rate of 800 μl/min. FIGS. 16A and 16B illustrate the results showing NaCl and KCl dose-response curves for the membrane-less sensor in FIG. 16A, and the ISP membrane-integrated sensor in FIG. 16B.

FIGS. 16A and 16B compare the differential response characteristics of both the membrane-less and the ISP-membrane integrated sensors with KCl and NaCl salts samples, providing some valuable insights to their performance. First, it can be observed that there is no significant disparity in the responses of both sensors to either salt sample at concentrations up to 20 ppm, as depicted in the semi-log dose-response curves. This suggests a limited selectivity of the sensor at concentrations below 20 ppm. However, beyond this threshold, the divergent response patterns of both sensor configurations become increasingly apparent, predominantly highlighted by the slopes of the curves.

In the example experiments, the sensor's specificity was evaluated by testing its performance with NaCl, KCl, and KNO₃ solutions. A significantly higher response for NaCl compared to the other salts was observed. This higher response underscores the sensor's specificity for Na+ ions, validating the effectiveness of the Na⁺-IP membrane in discriminating against other ions and providing selective affinity to target ions.

Notably, the membrane-less device exhibited a sensitivity of 0.00072 μA/ppm for NaCl and 0.00099 μA/ppm for KCl, resulting in a sensitivity ratio of approximately 0.73 to 1, which aligns with the mobility ratio of K+ to Na+ (0.7 to 1). On the other hand, the membrane-integrated microfluidic device 200 demonstrated a sensitivity of 0.00085 μA/ppm for NaCl and 0.00049 μA/ppm for KCl, translating to a sensitivity ratio of approximately 1.75 to 1. This suggests a significantly higher sensitivity to NaCl compared to KCl in the ISP membrane-integrated microfluidic device 200. It shows that there is a higher selectivity of carboxylate group-based membranes towards Na+ compared to K+, which could be attributed to the lower barrier energy of Na+ (10.21 kcal/mol) compared to K+ (12.33 kcal/mol). Consequently, the former exhibits greater affinity with the membrane 212 and faster transport through the membrane 212 pores.

Beyond its remarkable sensitivity, LOD, LOQ, and selectivity, the membrane-integrated microfluidic device 200 presents additional benefits in terms of cost-effectiveness and straightforward fabrication steps, meaning that it is an ideal candidate for large-scale production. The in-situ photopolymerization of the ISP membrane 212, electrode 214 fabrication achieved by injecting conductive paste into designated channels, and the use of microfluidic microchannels crafted from CNC-milled PMMA sheets and polycarbonate tape allow for complete automation, if high-scale production is required. Additionally, the microfluidic device 100, 200 can function as a disposable component integrated into portable devices equipped with an electrochemical measuring unit and fluid handling modules, such as small pumps and connectors. This alleviates the necessity for calibration, cleaning, and maintenance typically associated with more costly alternatives.

In the example experiments, the ISP membrane-integrated microfluidic device 200 demonstrated an LOD of 0.14 ppm, an LOQ of 0.25 ppm, and a sensitivity of 0.0024 μA/ppm, surpassing performance of other approaches. When compared to the membrane-less device, the ISP membrane showcased a significant improvement in LOD and LOQ by 44% and 73%, respectively. Additionally, the comparison of NaCl and KCl revealed a significantly higher selectivity to NaCl in ISP membrane-integrated sensor, with a Na+/K+ sensitivity ratio of approximately 1.75 to 1. The sensor performance was further improved when incorporating the Na⁺-imprinted polymer (Na⁺-IP) membrane such that the Na⁺-IP sensor demonstrated a LOD of 0.058 ppm, a LOQ of 0.19 ppm and a sensitivity of 0.0091 μA/ppm within the 0-100 ppm range. Moreover, the sensor showed a high level of specificity to the imprinted ion (Na+) when compared to other salt ions. These findings highlight the potential of the microfluidic device 200 for precise salt ion detection across diverse applications. The polymeric nature of the ISP membrane 212 sets it apart from natural receptors in sensing applications. This characteristic allows the ISP membrane 212 to endure challenging environmental conditions, making it well-suited for use in environmental monitoring. The significant scalability to detect different contaminants, disposability, and minimal maintenance requirements, especially when configured into a cartridge format with fluidic and electronic components, position the microfluidic device 100, 200 as an ideal choice for on-site, real-time monitoring in varied environments. Advantageously, the microfluidic device 100, 200 can be integrated into portable diagnostic platforms, contributing to advancements in environmental monitoring.

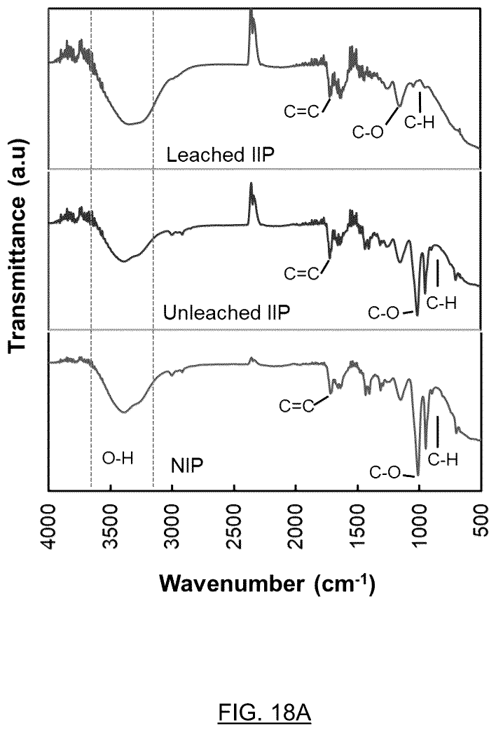

To further enhance the sensor's performance in terms of limit of detection (LOD), and limit of quantification (LOQ), sensitivity, and specificity, instead of using ion-exchangers as affinity elements in the IP membrane, sodium ions were imprinted in the membrane to form an ion-imprinted polymer membrane, thus creating a sodium-ion imprinted polymer (Na+-IP). FIG. 17 demonstrates schematic representation of the synthesis of the Na+-IP membrane.

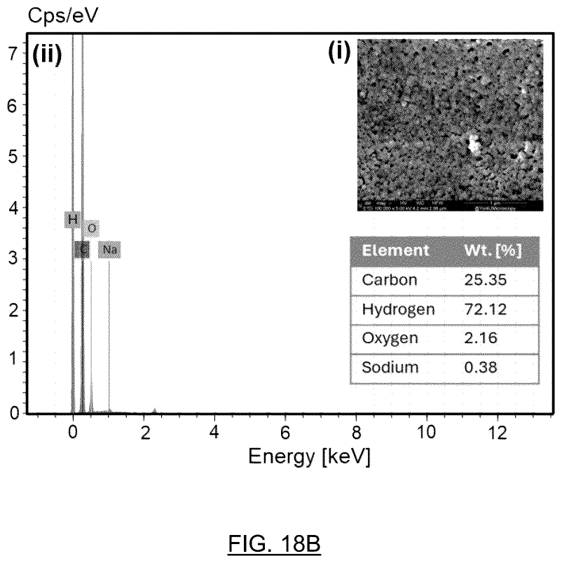

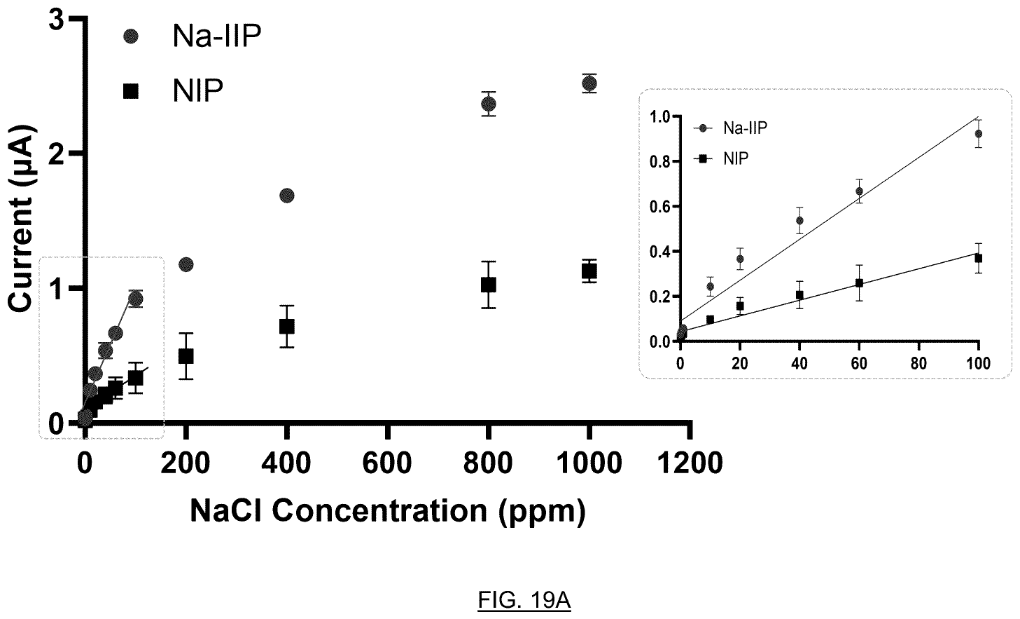

FIG. 18A shows the Fourier Transform Infrared Spectroscopy (FT-IR) spectra of leached and un-leached polymer membranes, highlighting the presence of C═O, C—O, and C═C bonds.

These correspond to the ester groups in Ethylene glycol dimethylacrylate (EGDMA) and the carboxylic acid and olefin functional groups in Methacrylic acid (MAA). FIG. 18B shows the energy dispersive X-ray analysis (i) and the scanning electron micrograph (ii) of the Na+-IP.

FIG. 19A compares two sensor configurations: one with a non-imprinted polymer (NIP) and the other with the Na⁺-IP, across a range of NaCl concentrations from 0.25 to 1000 ppm.

The chronoamperometry response for each concentration was measured at an optimized flow rate of 400 μL/min. Each test was conducted using three replicate devices, each tested three times to ensure consistency and repeatability. Based on the dose-response curves (FIG. 19A), the Na⁺-IP sensor demonstrated a LOD of 0.058 ppm and a LOQ of 0.19 ppm, with a sensitivity of 0.0091 μA/ppm within the 0-100 ppm range. In comparison, the NIP sensor exhibited a LOD of 0.17 ppm (193% higher), an LOQ of 0.92 ppm (384% higher), and a sensitivity of 0.0035 μA/ppm (62% lower) within the same range. Although the NIP sensor's response is lower than that of the Na⁺-IP sensor, its performance can be attributed to the carboxylic group of its functional monomer, MAA, which can participate in ion exchange.

FIG. 19B summarizes the trend of performance enhancement from the IP membrane to the non-imprinted polymer (NIP) membrane (i.e. Na+-IP without the template), to the Na+-IP membrane in detecting a sample of 200 ppm NaCl.

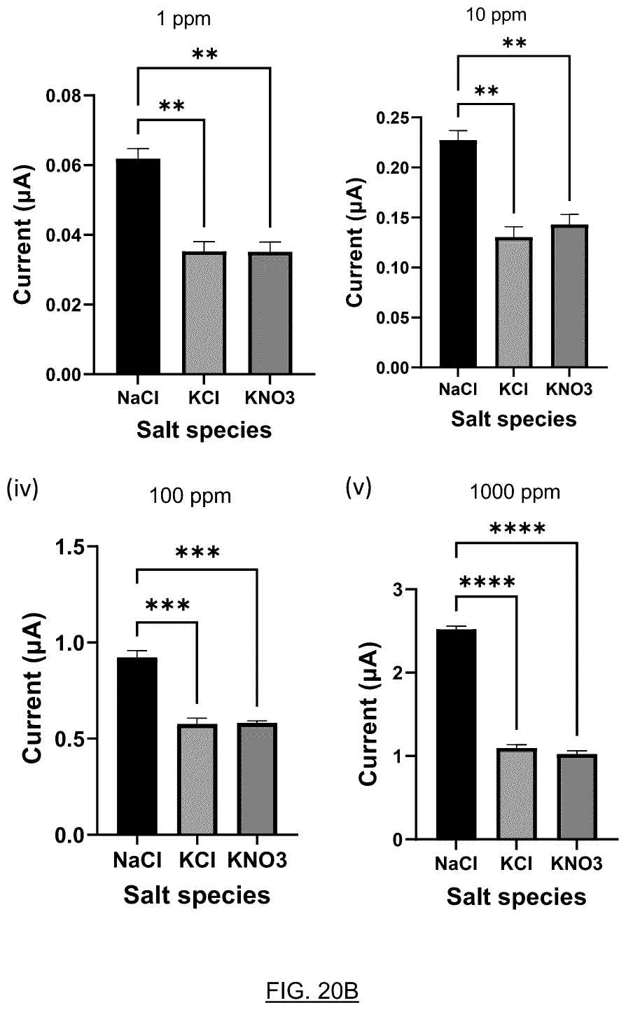

Given that the Na⁺-imprinted polymer (Na⁺-IP) membrane is designed to have binding sites specifically tailored for Na+ ions, the sensor's specificity was evaluated by testing its performance with NaCl, KCl, and KNO₃ solutions. A significantly higher response for NaCl compared to the other salts was observed. FIGS. 20A and 20B show the results of the specificity study with (i) dose response curves of the Na⁺-IP sensor for NaCl, KCl and KNO₃ across a 0-1000 ppm concentration range (template used to fabricate the membrane in all conditions was Na); and comparison of sensor responses for NaCl, KCl, and KNO₃ at (ii) 1 ppm, (iii) 10 ppm, (iv) 100 ppm, and (v) 1000 ppm. The sensor exhibited a significantly higher response to NaCl compared to KCl and KNO₃ at all tested concentrations, with the differences marked by statistical significance levels: *, **, ***, and **** indicating p-values of <0.05, <0.01, <0.001, and <0.0001, respectively. This higher response underscores the sensor's specificity for Na⁺ ions, validating the effectiveness of the Na⁺-IP membrane in discriminating against other ions.

While the above describes the microfluidic device 100, 200 for performing salinity measurements, it is understood that any suitable molecules, ions and cells can be imprinted to detect and measure a wide variety of suitable targets, such as for performing alkalinity measurements. Furthermore, it is understood that each standalone microstructure of the IP can function independently as a sensing and/or actuator when equipped with sensing materials (e.g., optosensings), or with magnetics (e.g., magnetically controlled microrobots which function as receptors/capturing/sensing units).

The stand-alone IPs of the present embodiments can be applied to a number of potential applications across a diverse range of sectors; for example, water security, food security, disease diagnostics and treatment, and drug discovery. For example, serving as selective receptors, carriers for pharmaceutical agents, and platforms for controlled release systems. These attributes find relevance in domains such as chemical analysis, environmental monitoring, medical diagnostics, pharmaceutical production, purification processes, and food quality assessment. The standalone multi-compartmental IP microstructures provide significant advancement for sensors and provide cost-effectiveness, heightened sensitivity, targeted detection, and the capability to identify multiple substances simultaneously. Moreover, the IP-based sensors of the present embodiments exhibit resilience to harsh conditions, making them suitable for demanding environments. This property makes them applicable for high-throughput Point-of-Need (PoN) testing, in contexts including environmental monitoring and medical diagnostics. Furthermore, the present embodiments can be used for improved detection of pathogens. The stability of the IP microstructures allows the sensors to detect individual molecules, and even entire pathogens. This capability is valuable for swift and cost-effective pathogen detection, with implications for both environmental monitoring and medical diagnosis.

Although the invention has been described with reference to certain specific embodiments, various modifications thereof will be apparent to those skilled in the art without departing from the spirit and scope of the invention as outlined in the claims appended hereto.

1. A method for fabricating imprinted polymers for capture or detection of biological or chemical substances, the method comprising:
preparing one or more prepolymerization mixtures, each prepolymerization mixture comprising a respective target template, the target template comprising one or more target molecules, one or more target ions, or one or more target cells;
directing each of the one or more prepolymerization mixtures into a respective microchannel of one or more microchannels of a microfluidic device;
polymerizing the prepolymerization mixture into imprinted polymers having a targeted structure by directing a heat source or a light source, or both, at the one or more microchannels; and
providing the imprinted polymers for capture or detection of the biological or chemical substances.

2. The method of claim 1, wherein the targeted structure of the imprinted polymers comprises one or more membranes or one or more pillars.

3. The method of claim 2, wherein the one or more membranes or the one or more pillars comprise imprinted polymers for more than one target template.

4. The method of claim 2, wherein the one or more membranes or the one or more pillars each comprise a layer of non-imprinted polymer at a core.

5. The method of claim 1, wherein the targeted structure of the imprinted polymers are droplets, the method further comprising outputting the droplets.

6. The method of claim 5, further comprising curing the droplets into particles.

7. The method of claim 1, wherein, where there is a plurality of microchannels, each of the microchannels have a prepolymerization mixture with a different target template directed therethrough, wherein each of the microchannels merge prior to the application of the heat source and/or the light source, and wherein the imprinted polymers are multiplex.

8. The method of claim 1, wherein a mask is located between the heat source and/or the light source and the one or more microchannels comprising the prepolymerization mixture, the mask is configured to permit selective polymerization of local areas of the prepolymerization mixture to govern the targeted structure of the imprinted polymers.

9. The method of claim 2, further comprising integrating electrodes into a housing that houses the one or more membranes or the one or more pillars to form a sensor.

10. The method of claim 1, wherein the prepolymerization mixture comprises a single target template, and wherein the imprinted polymers are singleplex.

11. A microfluidic device for fabricating imprinted polymers for capture or detection of biological or chemical substances, the microfluidic device comprising:
one or more input microchannels to each receive a prepared prepolymerization mixture, each prepolymerization mixture comprising a respective target template, the target template comprising one or more target molecules, one or more target ions, or one or more target cells; and
a downstream microchannel in fluid communication with the one or more input microchannels, the downstream microchannel configured to receive heat from a heat source or receive light from a light source, or both, to polymerize the prepolymerization mixture into imprinted polymers having a targeted structure.

12. The microfluidic device of claim 11, wherein the targeted structure of the imprinted polymers comprises one or more membranes or one or more pillars.

13. The microfluidic device of claim 12, wherein the one or more membranes or the one or more pillars comprise imprinted polymers for more than one target template.

14. The microfluidic device of claim 13, wherein the one or more membranes or the one or more pillars each comprise a layer of non-imprinted polymer at a core of the membrane.

15. The microfluidic device of claim 11, wherein the targeted structure of the imprinted polymers are droplets, wherein the downstream microchannel outputs the droplets.

16. The microfluidic device of claim 15, wherein the droplets are cured into particles.

17. The microfluidic device of claim 11, wherein, where there is a plurality of input microchannels, each of the input microchannels have a prepolymerization mixture with a different target template directed therethrough, and wherein the outputted imprinted polymers are multiplex.

18. The microfluidic device of claim 11, further comprising a mask located between the heat source and/or the light source and the one or more input microchannels comprising the prepolymerization mixture, the mask is configured to permit selective polymerization of local areas of the prepolymerization mixture to govern the targeted structure of the imprinted polymers.

19. The microfluidic device of claim 11, wherein the prepolymerization mixture comprises a single target template, and wherein the outputted imprinted polymers are singleplex.

20. A microfluidic device for detection or measurement of a target analyte, the target analyte comprising a molecule, ion, or cell, the microfluidic device comprising:
a housing;
an imprinted polymer situated in the housing, the imprinted polymer fabricated using a prepolymerization mixture comprising one or more target templates for the target analytes and that is polymerized in one or more microchannels; and
electrodes integrated in the housing, the electrodes in communication with the imprinted polymer to form a sensor.
